(19) United States
(12) Patent Application Publication
(10) Pub. No.: US 2019/0312892 A1
(43) Pub. Date: Oct. 10, 2019

(54) ONBOARD CYBERSECURITY DIAGNOSTIC SYSTEM FOR VEHICLE, ELECTRONIC CONTROL UNIT, AND OPERATING METHOD THEREOF

(71) Applicant: ELECTRONICS AND TELECOMMUNICATIONS RESEARCH INSTITUTE, Daejeon (KR)

(72) Inventors: Byung-Ho CHUNG, Daejeon (KR); Hyeok-Chan KWON, Daejeon (KR); Sok-Joon LEE, Daejeon (KR); Joong-Yong CHOI, Sejong-si (KR)

(73) Assignee: ELECTRONICS AND TELECOMMUNICATIONS RESEARCH INSTITUTE, Daejeon (KR)

(21) Appl. No.: 16/375,288

(22) Filed: Apr. 4, 2019

(30) Foreign Application Priority Data
Apr. 5, 2018 (KR) 10-2018-0039776
Mar. 15, 2019 (KR) 10-2019-0029626

(51) Int. Cl. H04L 29/06; G06F 21/85; G07C 5/08; H04L 12/40

(52) U.S. Cl. CPC H04L 63/1416; G06F 21/85; H04L 2012/40215; H04L 12/40; H04L 2012/40273; G07C 5/0816

(57) ABSTRACT

Disclosed herein is an onboard cybersecurity diagnostic system for a vehicle, which may include at least one In-Vehicle Network (IVN) security diagnostic sensor configured to detect and diagnose an Electronic Control Unit (ECU) attack command on a communication bus; at least one ECU configured to control an actuator based on sensor data collected from a sensor, autonomously diagnose the integrity of ECU electronic control software, and diagnose the integrity of ECU electronic control data by combining the sensor data with a security diagnostic packet received from the at least one IVN security diagnostic sensor; and a cyber dashboard configured to display a security problem in the event of the security problem in the integrity of the ECU electronic control software or the ECU electronic control data.

### CROSS REFERENCE TO RELATED APPLICATIONS

This application claims the benefit of Korean Patent Application No. 10-2018-0039776, filed Apr. 5, 2018, and No. 10-2019-0029626, filed Mar. 15, 2019, which are hereby incorporated by reference in their entirety into this application.

### BACKGROUND OF THE INVENTION

### 1. Technical Field

The present invention relates to an onboard cybersecurity diagnostic system for a vehicle, an electronic control unit, and operation methods thereof.

### 2. Description of the Related Art

These days, a vehicle capable of autonomously driving without the intervention of a driver in such a way that onboard software therein recognizes driving conditions and determines whether there is a hazard using various types of sensors installed in the vehicle is actively being developed. Such software installed in a vehicle's onboard system aims to safely drive a vehicle through electronic control of steering, acceleration, a brake system, and the like. Therefore, the integrity of vehicle sensors, Electronic Control Units (ECUs), and onboard system software should be guaranteed in order to secure vehicle safety, and it is very important to secure a technical means for diagnosing a problem and immediately taking action in response thereto in order to prevent the problem from causing an accident. As conventional technologies for achieving this, there are an Onboard Diagnostics (OBD) system and an Unified Diagnostic Services (UDS) system, which are international standards. These systems retrieve diagnostic trouble codes and freeze-frame data using a standardized diagnostic interface, thereby enabling the causes of a physical fault in a vehicle to be identified and fixed. However, the conventional technologies have a limitation in that it is impossible to diagnose the corruption of vehicle's onboard system software caused by a cyberattack and malfunctions resulting therefrom. Cases of invasion in which various types of cyberattacks, for example, the inflow of malicious code in a vehicle's internal system, hacking of an in-vehicle control network, causing sensor recognition errors, and the like, break the integrity of onboard system software and cause an ECU to malfunction are continuously reported. In this situation, when a vehicle's onboard system software damaged by a cyberattack causes an accident, the conventional technology may not provide a means for determining whether the cause of the accident is a physical defect, such as the deterioration of sensors or the fault of an ECU, a driver's mistake, or vehicle system software damaged by a cyberattack. Accordingly, required is a technical solution for autonomously diagnosing whether a vehicle's onboard system in which software is embedded is in a defective state caused by a cyberattack and providing notification of a malfunction in order to fix the cause thereof.

### SUMMARY OF THE INVENTION

An object of the present invention is to provide an onboard cybersecurity diagnostic system for a vehicle, an electronic control unit (ECU), and operation methods thereof, which autonomously diagnose a cybersecurity problem in a vehicle's onboard system using an onboard diagnostic (OBD) interface, such as OBD2, MVCI, DOIP, or the like, and display freeze-frame data, which is data from the sensors and components of the vehicle at the time when a fault by a cyberattack is detected, in an environment in which the vehicle sensors and onboard ECUs are connected with each other via an internal network.

An onboard cybersecurity diagnostic system for a vehicle according to an embodiment of the present invention may include at least one In-Vehicle Network (IVN) security diagnostic sensor configured to detect and diagnose an Electronic Control Unit (ECU) attack command on a communication bus; at least one ECU configured to control an actuator based on sensor data collected from a sensor, autonomously diagnose the integrity of ECU electronic control software, and diagnose the integrity of ECU electronic control data by combining the sensor data with a security diagnostic packet received from the at least one IVN security diagnostic sensor; and a cyber dashboard configured to display a security problem in the event of the security problem in the integrity of the ECU electronic control software or the integrity of the ECU electronic control data.

In an embodiment, the communication bus may include a vehicle communication bus.

In an embodiment, the communication bus may include a gateway for connection with the outside of the vehicle and the internal communication bus of the vehicle.

In an embodiment, the onboard cybersecurity diagnostic system may further include a cybersecurity diagnostic tool configured to scan data stored in the IVN security diagnostic memory of the at least one IVN security diagnostic sensor and security diagnostic data stored in the diagnostic memory of the at least one ECU, thereby performing precision test.

In an embodiment, the at least one IVN security diagnostic sensor may include an IVN attack detection sensor configured to identify the driving state of the vehicle, identify an attacker device and an attack target ECU, and detect a cyberattack; an IVN security diagnostic memory configured to store information about the identified attacker device and the identified attack target ECU when the cyberattack is detected; and an IVN security diagnostic software block for generating a security diagnostic trouble code (DTC) and security freeze-frame data based on a cyberattack detection result stored in the IVN security diagnostic memory.

In an embodiment, the at least one IVN security diagnostic sensor may generate a security diagnosis alarm packet using the security DTC and the security freeze-frame data and transmit the security diagnosis alarm packet to the identified attack target ECU and the cyber dashboard.

In an embodiment, the IVN attack detection sensor may identify the attacker device and the attack target ECU by analyzing the reception characteristics of a Controller Area Network (CAN) packet on the communication bus after identifying the driving state of the vehicle.

In an embodiment, the IVN attack detection sensor may extract a set of characteristics for uniquely identifying an ECU, thereby detecting whether the attacker device transmits a CAN_ID for a forcible control attack on the ECU and identifying the ECU at which the attack is aimed.

In an embodiment, the IVN attack detection sensor may extract characteristics of an ECU fingerprint and analyze a correlation between a received CAN_ID and the ECU, thereby identifying the attacker device and the attack target ECU.

In an embodiment, the ECU fingerprint may include a time interval at which the CAN_ID is received, a frequency with which the CAN_ID is received, or a period at which the CAN_ID is received as the statistical characteristic value of a received CAN message.

In an embodiment, the ECU fingerprint may include a reception power value as the physical characteristic value of the CAN packet, which is measured at a CAN transceiver.

In an embodiment, the IVN attack detection sensor may detect an attack using the driving state of the vehicle and an attack detection rule, and the attack detection rule may include a detection rule for an individual CAN packet and a detection rule using a time-series correlation between CAN packets received over time.

In an embodiment, the security DTC may include a code for differentiating an area in which an attack has occurred and for diagnosing the type of the attack or damage caused by the attack.

In an embodiment, the security DTC may include an MIL code for immediately lighting a cybersecurity Malfunction Indicator Lamp (MIL) on the cyber dashboard when a cyberattack is serious enough to compromise the safety of the vehicle so it is necessary to urgently respond thereto.

In an embodiment, the security freeze-frame data may include different data depending on a device in which the security DTC is generated and a condition under which an attack has occurred.

In an embodiment, the at least one ECU may include ECU security diagnostic memory for storing an ECU security diagnostic trouble code and ECU security freeze-frame data, which correspond to a result of verification of the integrity of the ECU electronic control software.

An electronic control unit (ECU) for controlling an actuator according to an embodiment of the present invention may include a hardware security module configured to verify the integrity of ECU electronic control software; and ECU security diagnostic memory configured to store a sensor/onboard diagnostic (OBD) parameter ID, sensor data, a security state of the sensor data, an ECU security diagnostic trouble code (DTC), and ECU security freeze-frame data. Here, the ECU electronic control software may verify the integrity of ECU control data by combining the sensor data received from a sensor with security diagnostic data received from an In-Vehicle Network (IVN) security diagnostic sensor.

In an embodiment, the security state of the sensor data may include an attack sign value, which is calculated by taking a value measured by and input from the sensor and a diagnostic value received from the IVN security diagnostic sensor as input variables, and the number of times the ECU security DTC is continuously generated; the ECU security DTC may include content that represents a security problem by which the integrity of the ECU electronic control software and ECU control data of a specific ECU is damaged; and the ECU security freeze-frame data may include the sensor/OBD parameter ID, a time at which a diagnosis is made, data about a driving state, and ECU security diagnostic data related to the security problem, the ECU security diagnostic data including a result of diagnosing the integrity of the ECU electronic control software or a data value indicating a sign of an attack on the ECU electronic control software.

In an embodiment, the ECU electronic control software may set the ECU security DTC when the data value indicating the sign of the attack relative to the value measured by the sensor exceeds a tolerance limit and when a time-series sequence pattern of the values measured by the sensor is an abnormal sequence pattern.

An operation method of an onboard cybersecurity diagnostic system for a vehicle according to an embodiment of the present invention may include autonomously diagnosing, by an electronic control unit (ECU), a cybersecurity problem; and displaying a security state determined depending on a diagnosis result on a cyber dashboard. The ECU may include a hardware security module configured to verify the integrity of ECU electronic control software; and ECU security diagnostic memory configured to store a sensor/onboard diagnostic (OBD) parameter ID, sensor data, the security state of the sensor data, an ECU security diagnostic trouble code (DTC) and ECU security freeze-frame data, the ECU electronic control software verifying the integrity of ECU control data by combining the sensor data received from a sensor with security diagnostic data received from an In-Vehicle Network (IVN) security diagnostic sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary diagram that shows a vehicle that provides an onboard cybersecurity diagnostic system according to an embodiment of the present invention;

FIG. 2 is an exemplary diagram that shows a cybersecurity diagnostic method of a vehicle, in which a cybersecurity diagnostic tool according to an embodiment of the present invention is used;

FIG. 3 is an exemplary diagram that shows an In-Vehicle Network (IVN) security diagnostic sensor according to an embodiment of the present invention;

FIG. 4 is an exemplary diagram that shows the process in which, when an attacker attempts an attack on an ECU using a Control Area Network (CAN) communication bus, an IVN security diagnostic sensor according to an embodiment of the present invention detects the attack and performs diagnosis;

FIG. 5 is an exemplary diagram that shows an embodiment of an attack detection rule based on a driving state according to an embodiment of the present invention;

FIG. 6 is an exemplary diagram that shows the process of identifying an attacker device and an attack target device by analyzing the reception characteristics of a CAN packet according to an embodiment of the present invention;

FIG. 7 is an exemplary diagram that shows a method for generating a cybersecurity diagnostic trouble code (DTC) according to an embodiment of the present invention;

FIG. 8 is an exemplary diagram that shows an attack detection result and the configuration of IVN security diagnostic data according to an embodiment of the present invention;

FIG. 9 is an exemplary diagram that shows a CAN communication packet for cybersecurity diagnostics according to an embodiment of the present invention;

FIG. 10 is an exemplary diagram that shows an ECU having a cybersecurity-aware function according to an embodiment of the present invention;

FIG. 11 is an exemplary diagram that shows diagnosis and electronic control of an ECU according to an embodiment of the present invention;

FIG. 12 is an exemplary diagram that shows the configuration of ECU security diagnostic memory according to an embodiment of the present invention;

FIG. 13 is an exemplary diagram that shows an onboard cybersecurity diagnostic system for a vehicle according to an embodiment of the present invention;

FIG. 14 is a flowchart that shows the operation method of a cybersecurity diagnostic system for a vehicle according to an embodiment of the present invention; and

FIG. 15 is an exemplary diagram that shows a cybersecurity diagnostic device for a vehicle according to an embodiment of the present invention.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that those embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms.

These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, terms used herein are merely used to describe specific embodiments, and are not intended to limit the present invention. A singular expression includes a plural expression unless a description to the contrary is specifically pointed out in context.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

An onboard cybersecurity diagnostic system for a vehicle and the operation method thereof according to an embodiment of the present invention may provide a technical means for diagnosing and fixing not only physical faults (defects) but also damage (defects) caused by a cyberattack. The onboard cybersecurity diagnostic system for a vehicle and the operation method thereof according to an embodiment of the present invention may be applied not only to vehicles that can be diagnosed using a conventional method, such as cars, autonomous vehicles, unmanned vehicles, taxis, trucks, and the like, but also to autonomous vessels having an internal communication bus, the structure of which is similar to that of the internal communication bus of vehicles.

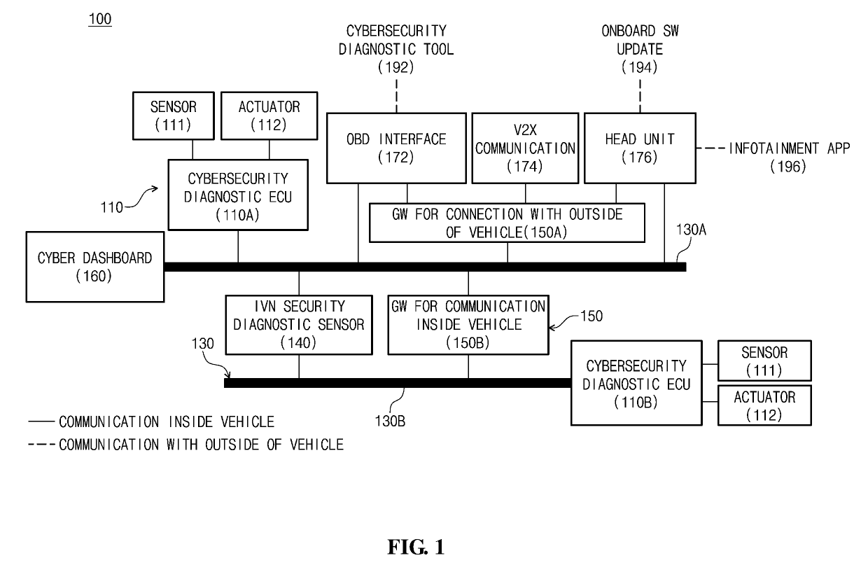

FIG. 1 is an exemplary diagram that shows the vehicle 100 providing an onboard cybersecurity diagnostic system according to an embodiment of the present invention. Referring to FIG. 1, the vehicle 100 may include one or more Electronic Control Units (ECUs) 110 (110A and 110B), at least one sensor 111, at least one actuator 112, an internal network of the vehicle 130 (130A and 130B), at least one In-Vehicle Network (IVN) security diagnostic sensor 140, a vehicle gateway 150 (150A and 150B), a cyber dashboard 160, an onboard diagnostic (OBD) interface 172, a Vehicle-to-Everything (V2X) communication ECU 174, and a head unit 176.

In an embodiment, the internal network 130 may include a first communication bus 130A and a second communication bus 130B. In an embodiment, each of the first communication bus 130A and the second communication bus 130B may be the internal communication bus of the vehicle. In an embodiment, each of the first communication bus 130A and the second communication bus 130B may be implemented using a vehicle communication method that follows an international standard, such as a controller area network (CAN), CAN with Flexible Data-Rate (CAN FD), Local Interconnect Network (LIN), FlexRay, Ethernet, or the like.

In an embodiment, the vehicle gateway 150 may conceptually include a gateway 150A for connection with the outside of the vehicle and a gateway 150B for communication within the vehicle.

In an embodiment, the gateway 150A for connection with the outside of the vehicle may filter traffic that flows from the outside to the inside of the vehicle via the OBD interface 172, the V2X communication ECU 174, the head unit 176, and the like, which are located at the boundary between the external system and the internal system of the vehicle, and may provide connectivity to the internal communication bus.

In an embodiment, the gateway 150B for communication inside the vehicle may provide functions of routing and protocol conversion between the internal devices connected via the internal communication buses 130A and 130B or the gateway 150A for connection with the outside of the vehicle.

The internal devices of the vehicle 100 may include the ECUs 110, the IVN security diagnostic sensor 140, the cyber dashboard 160, the OBD interface 172, the V2X communication ECU 174, the head unit 176, and other electronic systems for supporting autonomous driving, although not illustrated in the drawing.

Generally, a hacker may illegally access the internal communication bus 130A, such as a CAN or the like, using the OBD interface 172 and transmit an attack command for forcibly controlling the ECU 110. Here, if the ECU 110 is not able to recognize such an ECU control attack, the ECU 110 subjected to the cyberattack may malfunction.

The conventional method for diagnosing a physical fault is problematic in that it cannot recognize a malfunction that arises from the erroneous operation of the software of the ECU 110 attributable to a cyberattack. Meanwhile, various kinds of vehicle software for providing services, such as remote update 194 of onboard software, an infotainment app 196, and the like, may be installed in the head unit 176. These services may be provided from the server of an automotive company using a mobile communication network, or may be provided using a user's smartphone service app connected via an external communication link, such as Wi-Fi or Bluetooth. If there is malware illegally installed in the head unit 176, if normal software installed therein is illegally altered, or if it is possible to access the internal communication bus 130A, such as CAN or the like, through remote hacking, an attacker or hacker may monitor the communication bus and transmit an attack command for forcibly controlling the ECU 110.

Meanwhile, when an automotive company attempts the remote update 194 of the onboard software of an autonomous driving ECU, an attacker may hack into the ECU and install malware therein or illegally manipulate the ECU, whereby the onboard software (firmware) may be altered. Here, the integrity of the electronic control function thereof is damaged, which may cause a malfunction. In this case, the conventional method may not diagnose the software defect caused by the cyberattack. Therefore, in an environment in which a cyberattack is possible as described above, technology for autonomously diagnosing whether the integrity of the ECU electronic control software and ECU control (sensor) data is broken, that is, whether there is a cybersecurity problem in the ECU, and displaying cybersecurity freeze-frame data to a driver or an automotive technician is required. When a vehicle system damaged by a cyberattack causes an accident, the conventional method for diagnosing physical faults is not able to detect whether the cause of the accident is the deterioration of vehicle parts, a driver's mistake during driving, or a defect caused by a cyberattack.

In contrast, the onboard cybersecurity diagnostic system for a vehicle according to an embodiment of the present invention enables a vehicle to autonomously diagnose a cybersecurity problem, which may cause a malfunction by illegally damaging the ECU control software and ECU control (sensor) data of the vehicle, and to output the security state to an attack target ECU, a driver or an automotive technician. Accordingly, in an environment in which a cyberattack is possible, the driver may detect whether a vehicle maintains a safe state from the aspect of cybersecurity and identify the problem that the vehicle has, whereby the safety of the driver may be improved.

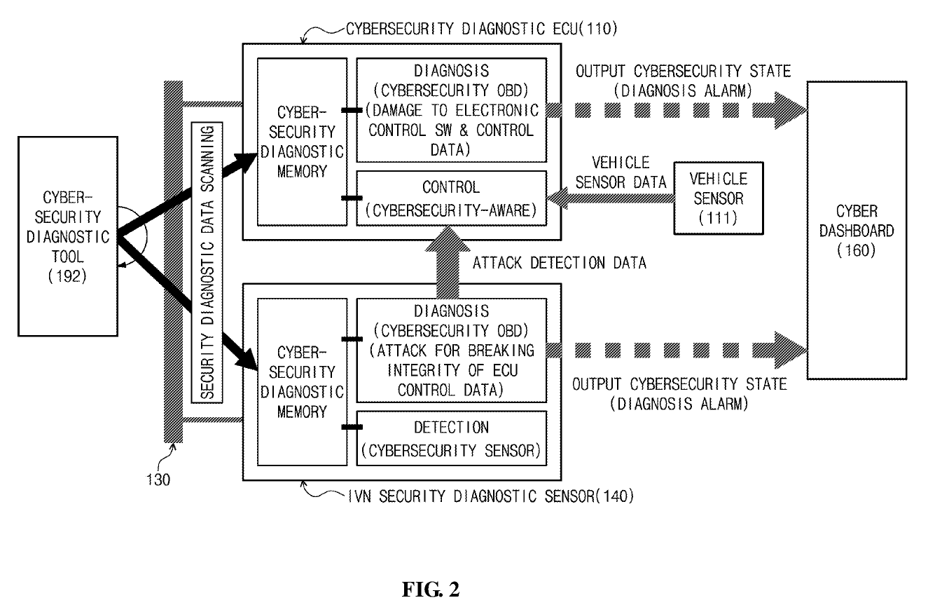

FIG. 2 is an exemplary diagram that shows the cybersecurity diagnostic method of a cybersecurity diagnostic system for a vehicle, in which a cybersecurity diagnostic tool according to an embodiment of the present invention is used. Referring to FIG. 1 and FIG. 2, the cybersecurity diagnostic system for a vehicle may include an IVN security diagnostic sensor 140, ECUs 110, a cyber dashboard 160, and a cybersecurity diagnostic tool 192. The vehicle 100 may include the IVN security diagnostic sensor 140 in the internal network 130. In an embodiment, the IVN security diagnostic sensor 140 may detect and diagnose an ECU attack command (that is, false data for forcibly controlling the ECU) on the vehicle communication bus 130 and notify the ECU 110, assumed to be the target of the attack, of the occurrence of the attack.

In an embodiment, the IVN security diagnostic sensor 140 may be embodied in the form of a device to be exclusively used for a specific communication bus 130. In another embodiment, the IVN security diagnostic sensor 140 may be embodied in the form of a vehicle gateway device 150 in which multiple communication buses are integrated.

In an embodiment, the ECU 110 may autonomously diagnose whether the integrity of ECU electronic control software is broken. Also, the ECU 110 combines data received from the sensor 111 of the vehicle 100 with data received from the IVN security diagnostic sensor 140, thereby diagnosing whether the integrity of ECU control data is broken. In the event of a security problem in the ECU electronic control software or the ECU control data, a cybersecurity alarm may be output to a driver through the cyber dashboard 160.

In an embodiment, the cybersecurity diagnostic tool 192 may provide a precision test function by scanning security diagnostic data stored in the diagnostic memory of the IVN security diagnostic sensor 140 and the ECU 110.

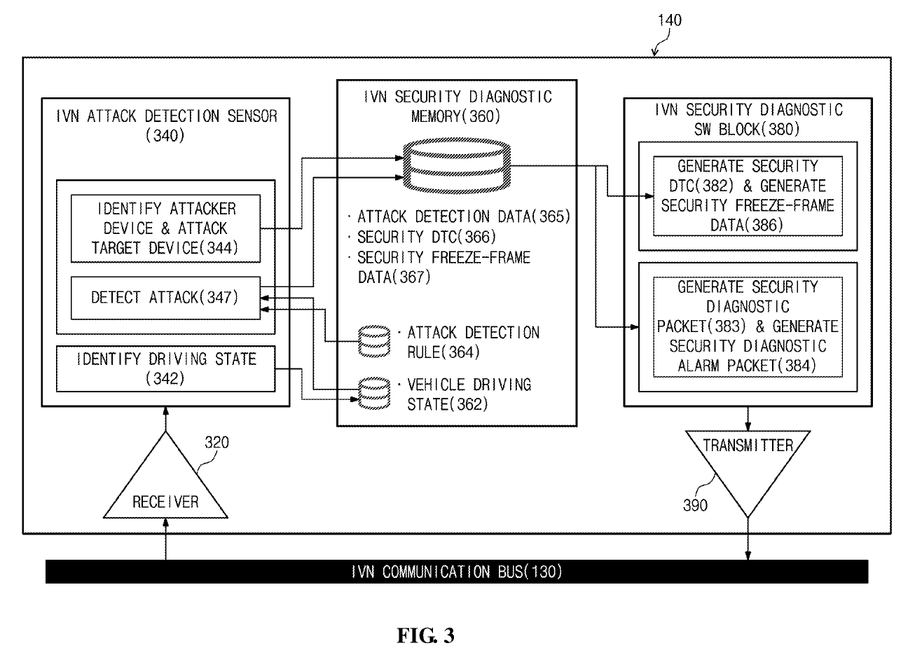

FIG. 3 is an exemplary diagram that shows the IVN security diagnostic sensor 140 according to an embodiment of the present invention. Referring to FIG. 3, the IVN security diagnostic sensor 140 may include a receiver 320, an IVN attack detection sensor 340, IVN security diagnostic memory 360, an IVN security diagnostic software block 380, and a transmitter 390. The IVN security diagnostic sensor 140 combines the attack detection sensor 340 with onboard diagnostic techniques 360 and 380, thereby configuring the IVN security diagnostic memory 360 and outputting a diagnostic result to the attack target ECU 110 and the cyber dashboard 160.

The IVN attack detection sensor 340 may include the function of identifying a driving state 342, the function of identifying an attacker device and an attack target ECU 344, and the function of detecting a cyberattack 347. In an embodiment, the IVN attack detection sensor 340 may detect whether a cyberattack occurs in the current driving state of the vehicle 100, for example, when the vehicle 100 is parked, stopped, driven forward, reversed, or the like. If it is determined that a cyberattack has occurred, the IVN attack detection sensor 340 identifies the attacker device and the attack target ECU 110 as the attack detection result and stores the attack detection result in the IVN security diagnostic memory 360.

The IVN security diagnostic software block 380 may generate a cybersecurity diagnostic trouble code (DTC) 366 and cybersecurity freeze-frame data 367 based on the cyberattack detection result stored in the IVN security diagnostic memory 360 and output an alarm to the ECU 110 identified as the attack target and the cyber dashboard 160 based on the cybersecurity DTC 366 and the cybersecurity freeze-frame data 367, thereby providing a functional means through which a security state is diagnosed using the cybersecurity diagnostic tool 192.

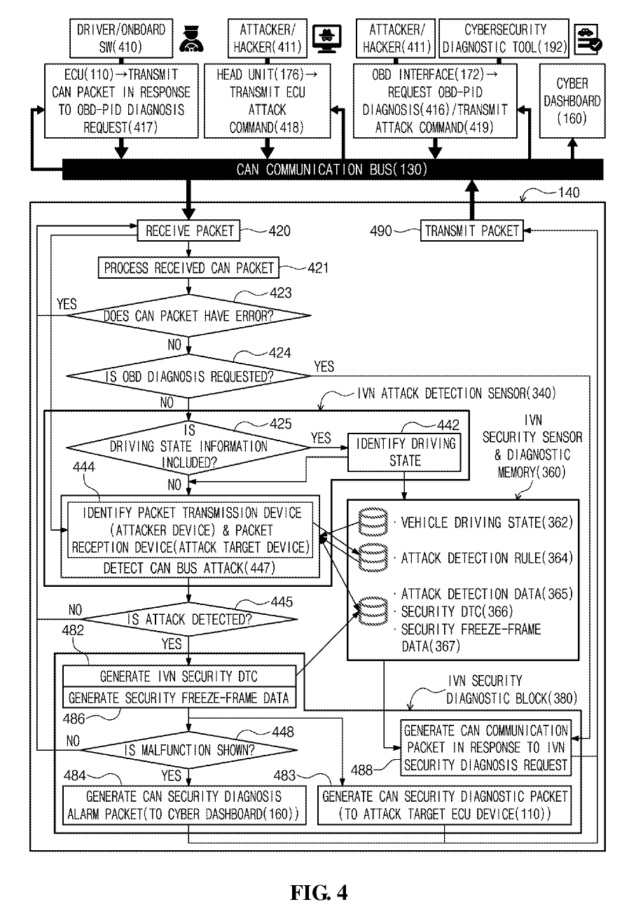

FIG. 4 is an exemplary diagram that shows the process in which, when an attacker attempts an attack on the ECU 110 using the CAN communication bus 130, the IVN security diagnostic sensor 140 according to an embodiment of the present invention detects the attack and perform diagnosis.

A packet 420 received through the CAN communication bus 130 may be at least one of a diagnosis request message 416 transmitted from the OBD interface 172, a response message 417 transmitted by the ECU 110 in response to the diagnosis request, a message containing information about the states of sensors, which is periodically transmitted by the ECU 110, an ECU attack command 418 illegally transmitted by an attacker or hacker 411 that hacks into the head unit 176, an ECU attack command 419 transmitted by an attacker or hacker 411 that hacks into the OBD interface 172, and a communication packet that a vehicle's internal device connected with the communication bus 130 transmits to the CAN communication bus. That is, various kinds of messages and packets may be received.

In an embodiment, the IVN attack detection sensor 340 may perform error handling 421 with respect to whether the CAN_ID and data of the received packet 420 match the format of a CAN communication message or whether the transfer rate thereof is appropriate.

When a packet for requesting onboard diagnostics 424 is received without error, the IVN security diagnostic sensor 140 may convert the IVN security DTC 366 and the cybersecurity freeze-frame data 367 stored in the diagnostic memory 360 into a diagnosis response packet (488) and transmit the diagnosis response packet through the CAN communication bus 130.

If the received packet 420 contains information about the vehicle's driving state 362, the IVN security diagnostic sensor 140 identifies the driving state (442) and records the vehicle's driving state 362 in the diagnostic memory. The identified driving state 362 may be used for a detection rule 364 for detecting a cyberattack.

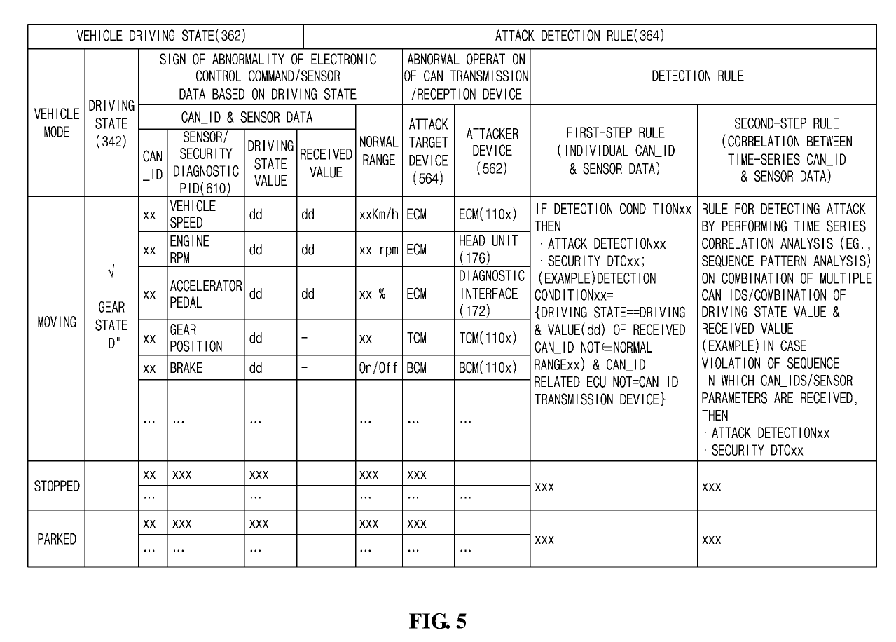

FIG. 5 is an exemplary diagram that shows an embodiment of an attack detection rule based on a driving state according to an embodiment of the present invention. Referring to FIG. 5, the memory for storing the driving state 362 of a vehicle may include a vehicle mode, a current driving state, and a CAN_ID and sensor data values received in the current driving state. Here, the vehicle mode indicates whether the vehicle is parked, stopped, driven forwards, or reversed, which is determined by analyzing the CAN_ID, which is broadcast through the CAN communication bus, and the sensor data values, such as vehicle speed, engine RPM, a brake state, a gear position, and the like.

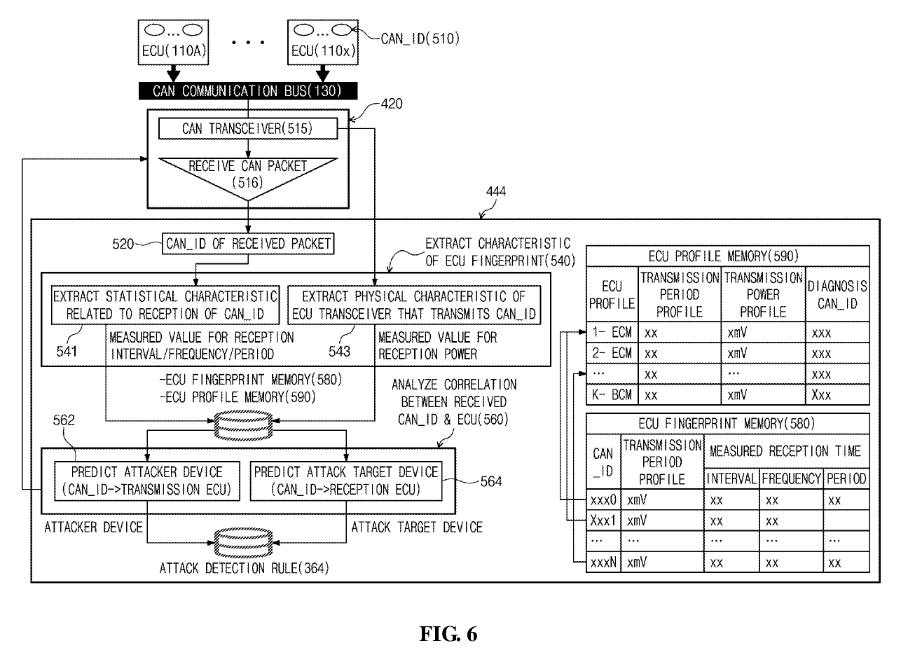

In an embodiment, after identifying the driving state (442), the IVN attack detection sensor 340 analyzes the reception characteristics of the CAN packet, as shown in FIG. 6, thereby providing a functional means for identifying an attacker device and an attack target device (444). To this end, a set of characteristics for uniquely identifying an ECU is extracted, whereby the transmission device (or the attacker device) that transmits the CAN_ID 520 for a forcible control attack on the ECU or the ECU 110 at which the attack is aimed may be identified (562 and 564). In order to identify the attacker and the attack target device (444), two key functions, which are the function of extracting ECU fingerprint characteristics 540 and the function of analyzing a correlation between a received CAN_ID and an ECU 560, may be used.

The ECU fingerprint according to an embodiment of the present invention may be implemented in two forms. First, the ECU fingerprint may include a time interval, a frequency or a period with respect to the reception of a CAN_ID 520 as the statistical characteristic value 541 of the received CAN messages. The second form of the ECU fingerprint may include reception power, which is measured at the CAN transceiver 515, as the physical characteristic value 543 of the CAN packet.

Meanwhile, the attack detection rule 364 may include two steps of detection rules. The first-step detection rule is a detection rule for individual CAN packets, and the second-step detection rule uses the time-series correlation between CAN packets received over time.

In an embodiment, the first-step detection rule may include various detection rules by combining three detection variables related to the specific driving state of a vehicle. Here, the three detection variables are the validity of a received electronic control command (CAN_ID), a sign of an abnormality of a received CAN_ID data value, and information about whether the device transmitting the CAN_ID (electronic control command (data)) is operating abnormally.

In an embodiment, the second-step detection rule may include a rule for detecting a sign of an abnormality assumed to be an attack by performing state transition analysis or time-series (sequence pattern) analysis using a series of received electronic control commands (CAN_IDs).

For example, in FIG. 5, when a vehicle is moving forwards at 60 km/h, if a command to shift into a reverse gear is input, it may be detected as a sign of an abnormality assumed to be an attack. In another example, when a driver shifts a gear into a reverse position, a CAN packet command (CAN_ID) for displaying a reverse signal on the instrument cluster, a CAN packet command for setting an alarm on a bumper sensor, and a CAN packet command for displaying a rear camera image on the head unit may be sequentially generated. Here, if this sequence pattern is violated, this may be detected as a sign of an abnormality

Meanwhile, it should be understood that the method by which the IVN attack detection sensor 340 detects a cyberattack (447) may be implemented using not only the detection method shown in FIG. 5 but also various conventional methods. Also, it should be understood that the present invention is not limited to the method in which the IVN security diagnostic sensor 140 is configured using the CAN bus attack detection function (477), to which the conventional method is applied.

In an embodiment, when the IVN attack detection sensor 340 detects a received CAN packet 420 (470) and when the received CAN packet is determined to be intended for an attack, the IVN security diagnostic software block 380 may generate a cybersecurity diagnostic trouble code (DTC) 366 and cybersecurity freeze-frame data 367, which are configured so as to identify what kind of attack occurred and where the attack occurred.

FIG. 6 is an exemplary diagram that shows the process of identifying an attacker and an attack target device (444) through analysis of the reception characteristics of a CAN packet according to an embodiment of the present invention. Referring to FIG. 6, a CAN communication environment may be configured such that different ECUs 110 share a single CAN communication bus 130. Each ECU 110 connected to the CAN communication bus 130 has one or more CAN_IDs 510, and may communicate using only the CAN_IDs, rather than using a destination address. The lower the CAN_ID number, the higher the communication priority thereof. These characteristics may be used as correlation analysis data for predicting the correlation between a specific ECU 110 and the transmitted and received CAN_IDs.

Accordingly, a CAN message has the following characteristics from a statistical aspect. The lower the CAN_ID number, the higher the frequency with which the CAN message is received. Also, an ECU in a transmission or an engine has a lower CAN_ID number than an ECU in a vehicle body or chassis and has a short transmission period because of the high communication priority thereof.

In an embodiment, from a physical aspect, CAN communication may be performed using different voltages. For example, the transceiver of a CAN packet transmission device represents bit values of ‘0’ or ‘1’ using different transmission voltages, in which case the respective ECUs may have individual transmission voltages due to the manufacturing tolerance of the transceiver power device thereof.

In the method of identifying an attack target device according to an embodiment of the present invention, these statistical and physical characteristics are defined as fingerprint characteristics for uniquely identifying each ECU, and ECU fingerprint memory 580 may be configured by extracting these characteristics (540).

In an embodiment, first, ECU profile memory 590 may be configured in order to identify an attacker device and an attack target device using a received CAN_ID.

In an embodiment, the ECU profile memory 590 may store an ECU profile corresponding to a list of CAN_IDs related to a specific ECU, a sequence pattern of the CAN_IDs related to the ECU, the period at which the CAN_ID is received, the frequency with which the CAN_ID is received, and the CAN_ID reception power.

In an embodiment, the characteristics of a received CAN packet, stored in real time in the ECU fingerprint memory 580, are compared with characteristics in the ECU profile memory 590, whereby the correlation between the received CAN_ID and the ECU may be analyzed (560). Accordingly, the attacker device 562 and the attack target device 564 may be identified.

In an embodiment, information about the identified attacker device and the identified attack target device may be stored in memory for the attack detection rule 364 so as to be used in the process of detecting an attack on the CAN communication bus 130 (447).

In an embodiment, the IVN attack detection sensor 340 may detect an attack (447) using the vehicle's driving state 362 and the attack detection rule 364.

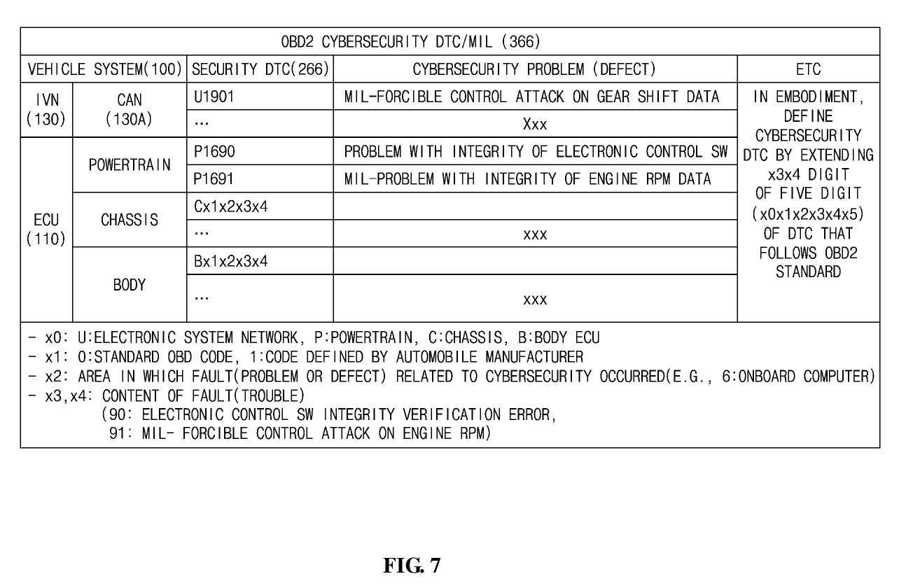

FIG. 7 is an exemplary diagram that shows a method for generating a cybersecurity diagnostic trouble code (DTC) 366 according to an embodiment of the present invention. Referring to FIG. 7, the cybersecurity DTC 366 is configured with five digits so as to follow the format of standard OBD codes, which are the conventional technology, and may use two of the digits, namely the third and fourth digits of the OBD code, for cybersecurity diagnosis.

In an embodiment, the cybersecurity DTC 366 may be configured to include a code through which whether a cyberattack occurred in the in-vehicle network 130 or in the ECU 110 of a powertrain, chassis, body, or the like may be detected and through which the type of the attack or the damage (or defect) caused by the attack may be diagnosed.

In an embodiment, the cybersecurity DTC 366 may include a MIL code for immediately lighting a Malfunction Indicator Lamp (MIL) on the cyber dashboard 160 when a cyberattack is serious enough to compromise the safety of a vehicle, making it necessary to urgently respond thereto.

In an embodiment, among the cybersecurity DTCs 366 based on the OBD2 standard, the DTC ‘U1901’ means that the code is defined by an automotive company and that it is necessary to immediately light a malfunction indicator lamp (MIL) in response to an attack that occurred on the in-vehicle network 130 in order to forcibly control a transmission. In another embodiment, the DTC ‘P1691’ means that a cybersecurity problem occurs because verification of the integrity of onboard computer software in the powertrain ECU 110 fails.

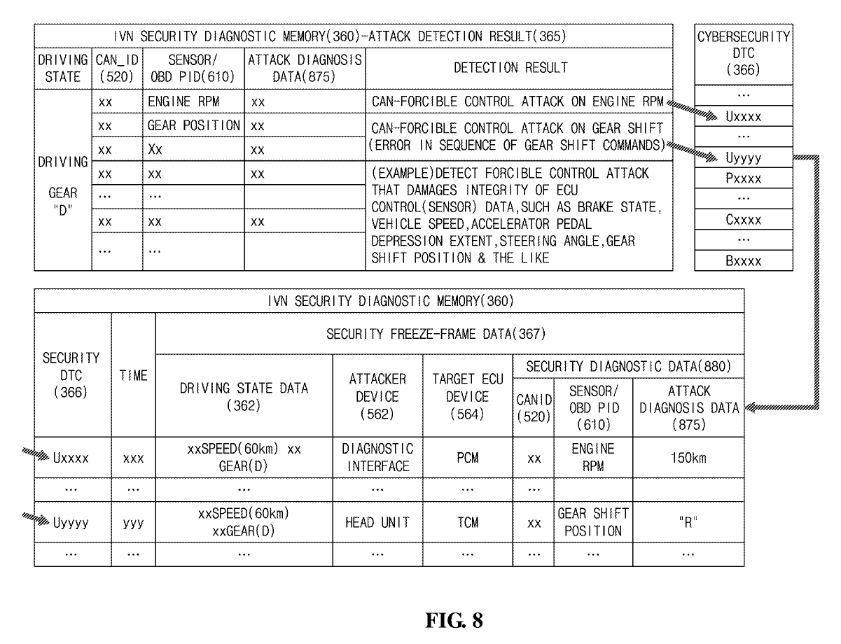

FIG. 8 is an exemplary diagram that shows another configuration of the attack detection result 365 and the IVN cybersecurity freeze-frame data 367. Referring to FIG. 8, when the attack detection result data 365 in the IVN security diagnostic memory 360 is converted into a cybersecurity DTC 366 and when cybersecurity freeze-frame data 367 is generated, stored, and managed, the IVN security diagnostic memory 360 may be configured.

As shown in FIG. 8, the IVN security diagnostic memory 360 may include a cybersecurity DTC 366, the time at which an attack is detected, information about an attacker device 562, information about an attack target ECU 564, a vehicle driving state 362 in which the attack occurred, and security diagnostic data 880. In an embodiment, the cybersecurity freeze-frame data 367 may include different data depending on the device related to the cybersecurity DTC 366 and the conditions under which the attack occurred.

In an embodiment, in the case of the DTC ‘U1901’ shown in FIG. 7, the vehicle speed, the engine state, the gear-shift state, and the like, acquired at the time at which the attack occurred, are included in the driving state “D”, and the security diagnostic data 880 may include the ECU attack data included in the received packet 420.

In an embodiment, when the generation of cybersecurity freeze-frame data 367 is completed, the security diagnostic software block 380 of the IVN security diagnostic sensor 140 may transmit the security diagnostic data 880 to the ECU 564 that is identified as an attack target. Accordingly, a means by which the ECU 564 is able to respond to the cyberattack using the diagnostic data received from the IVN security diagnostic sensor 140 may be provided.

When the cybersecurity DTC 366 corresponds to a serious defect, making it necessary to light a malfunction indicator lamp (MIL), the security diagnostic software block 380 generates a packet for the MIL (483) and transmits the packet to the cyber dashboard 160, thereby giving a warning to a driver.

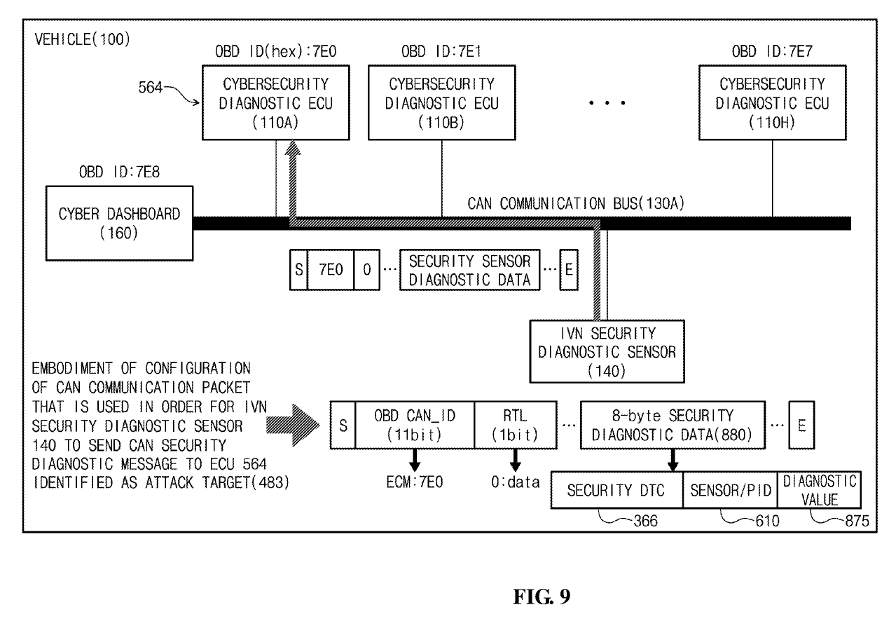

FIG. 9 is an exemplary diagram that shows a CAN communication packet for cybersecurity diagnostics according to an embodiment of the present invention. Referring to FIG. 9, in order for the IVN security diagnostic sensor 140 to transmit a security diagnostic packet to the attack target ECU 110 via the CAN communication bus 130, a CAN communication packet for onboard cybersecurity diagnostics may be configured.

In an embodiment, the CAN packet for security diagnostics is configured such that the CAN_ID of the ECU 564 identified as an attack target is set to the CAN_ID address, which is a receiver ID registered by the cybersecurity OBD software embedded in the ECU, such that an RTL bit is set to ‘0’ so as to indicate that the CAN packet includes diagnostic data, and such that a 8-byte data field contains the security diagnostic data 880 of the IVN security diagnostic sensor 140.

In an embodiment, the security diagnostic data 880 of the IVN security diagnostic sensor 140 may include a cybersecurity DTC 366, a sensor/OBD parameter ID 610 included in the ECU attack command, and a data value 875 used for the attack.

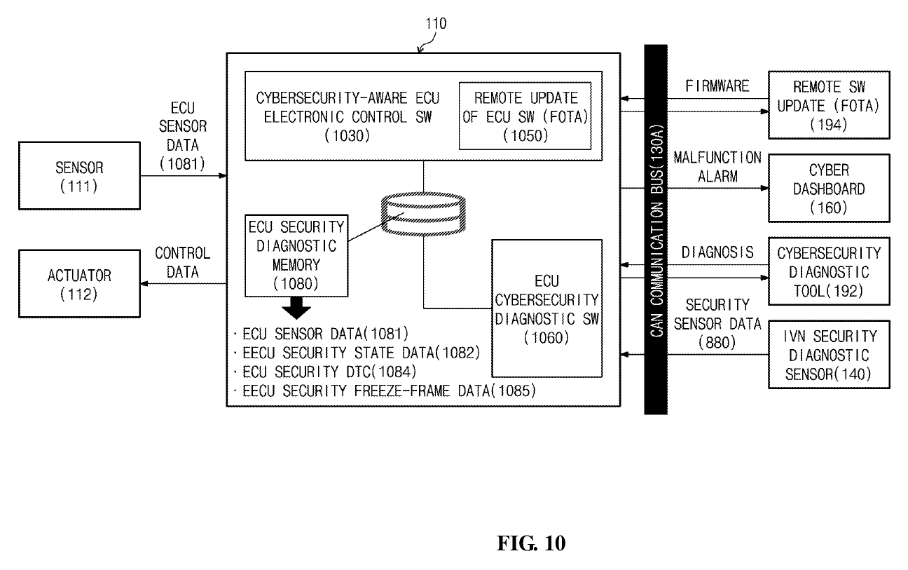

FIG. 10 is an exemplary diagram that shows the ECU 110 having a cybersecurity-aware function according to an embodiment of the present invention. Referring to FIG. 10, the ECU 110 checks the integrity of ECU electronic control software and ECU control data and electronically controls the actuator 112 based thereon.

In an embodiment, the ECU 110 may be configured by adding a cybersecurity-aware function to the conventional ECU, and may include cybersecurity-aware ECU control software 1030, ECU cybersecurity diagnostic software 1060, and ECU security diagnostic memory 1080. The cybersecurity-aware ECU control software 1030 may perform the remote update of ECU software (FOTA) (1050).

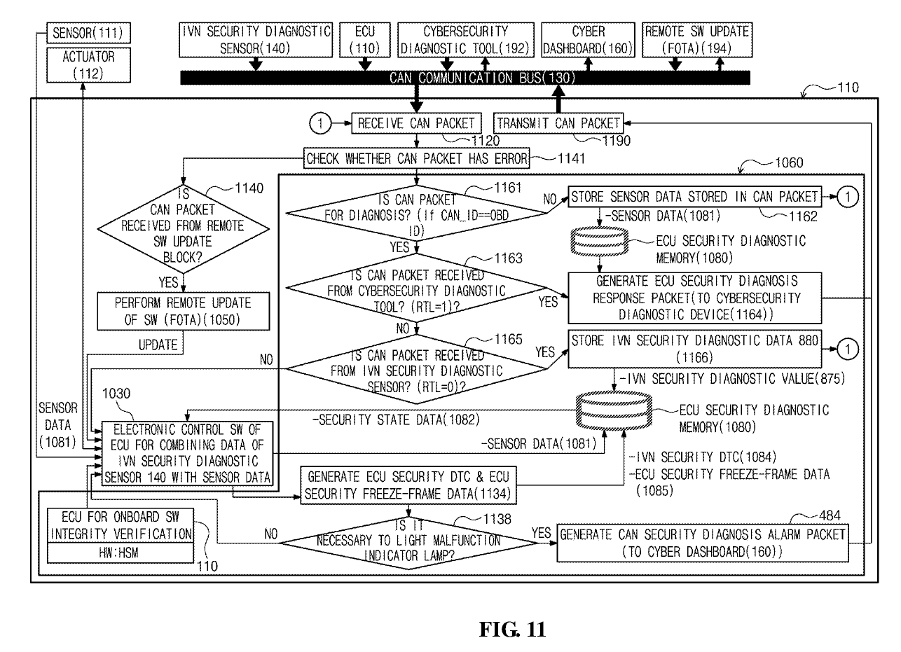

FIG. 11 is an exemplary diagram that shows diagnosis and electronic control of the ECU 110. Referring to FIG. 11, the function flow of software used for diagnosis and electronic control in the cybersecurity-aware ECU 110 is illustrated. Sensor data from the vehicle sensors 111 is input as the electronic control data of the ECU and is processed by the electronic control software 1030, and the actuator 112 may be operated depending on the processing result.

If the control data processed by the electronic control software 1030 is not data actually measured by the sensor 111 but false data for an attack, which is injected by an attacker, the ECU control software may cause the actuator 112 to malfunction. In order to solve this malfunction problem, the present invention uses the processing method of the ECU control software 1030, in which the integrity of ECU control data is verified by combining the data 1081 input from the sensor 111 with security diagnostic data 880 received from the IVN security diagnostic sensor 140.

As shown in FIG. 11, first, whether the received CAN packet 1120 contains an error is checked in the ECU 110. Then, when the received CAN packet is determined to be a packet for requesting remote diagnosis (1163), an ECU security diagnosis response packet may be generated (1164) and transmitted. When the received CAN packet 1120 is a sensor data packet (1161) or an IVN security diagnostic data packet (1165), the data value of the received CAN packet may be stored in the ECU security diagnostic memory 1080.

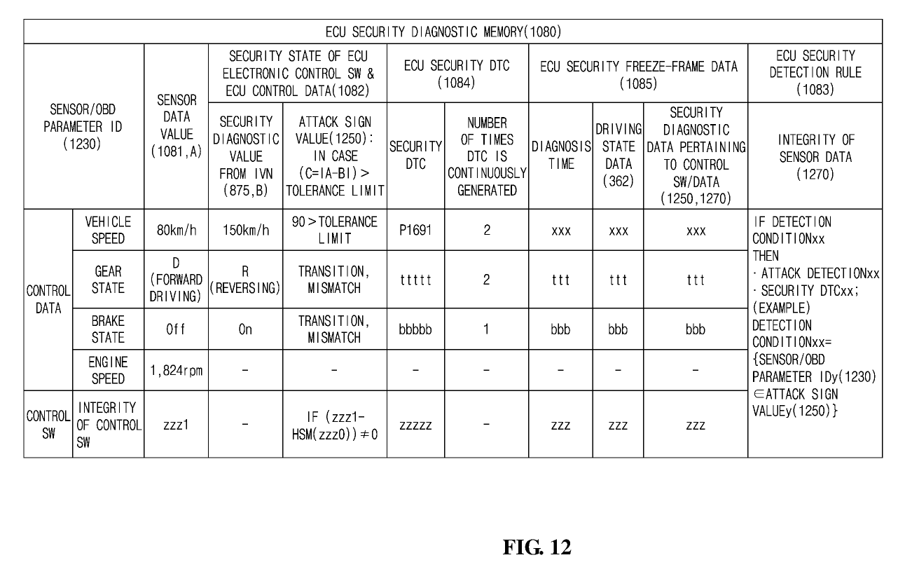

FIG. 12 is an exemplary diagram that shows the configuration of the ECU security diagnostic memory 1080 according to an embodiment of the present invention. Referring to FIG. 12, the ECU security diagnostic memory 1080 may include a sensor/OBD parameter ID 1230, sensor data 1081, the security state 1082 of the sensor data, an ECU security DTC 1048, and ECU security freeze-frame data 1085.

In an embodiment, the security state 1082 of the sensor data may include an attack sign value 1250, which is calculated by taking a measured value A 1081, input from the sensor, and a diagnostic value B 875, received from the IVN security diagnostic sensor 140, as input variables, and the number of times the corresponding ECU security DTC 1084 is continuously generated.

In an embodiment, the ECU security DTC 1084 may include content that represents a security defect that breaks the integrity of electronic control software of a specific ECU (e.g., an ECU in a powertrain, a chassis, or a body) or the integrity of ECU control (sensor) data. The ECU security DTC follows the configuration of the security DTC and the embodiment shown in FIG. 7.

In an embodiment, the ECU security freeze-frame data 1085 may include a sensor/OBD parameter ID 1230 related to a security defect, the time at which a diagnosis is made, the driving state data 362 at that time, and ECU security diagnostic data including the result of diagnosing the integrity of electronic control software 1270 or a data value indicative of an attack on the electronic control software 1250.

In an embodiment, the fact that an attack diagnosis value 875 reported by the IVN security diagnostic sensor 140 is stored in the ECU security diagnostic memory 1080 means that an attack attempt for forcibly controlling a vehicle sensor value, such as vehicle speed, RPM, or the like, is detected. However, the IVN security diagnostic value 875 may be a misdiagnosis; that is, a normal sensor value may be erroneously recognized as a cyberattack.

In order to reduce the possibility that the IVN security diagnostic value 875 is a misdiagnosis and to determine the integrity of the sensor value, that is, whether or not the sensor value is falsified by a cyberattack, the present invention may include the security state of ECU control software 1030 and sensor data 1082, specifically, the number of times an ECU security DTC 1084 is continuously generated and the attack sign value 1250, as security state indices.

In an embodiment, when the ECU control software 1030 processes sensor data, if the attack sign value 1250 relative to the sensor data value 1081, such as vehicle speed, a gear state, and the like, is diagnosed as exceeding a tolerance limit (e.g., exceeding 1.5 times the tolerance limit), the ECU security DTC 1084 may be set.

In an embodiment, in order to check the integrity of a sensor value, another attack detection method in which diagnosis is performed using the attack sign value 1250 relative to the sensor value 1081 and the abnormality of the time-series sequence pattern of received sensor values may be used.

In an embodiment, when the sensor value 1081 for the vehicle speed 1230 is 80 km/h at t0 msec., when the brake sensor state value is “on” at t1 msec., and when the vehicle speed sensor value is 150 km/h at t2 msec., because the sequence pattern of the sensor values received over time is abnormal in the current driving state and because the attack sign value 1250 of the vehicle speed sensor exceeds the tolerance limit during the time period (t2-t0 msec.), the ECU electronic control software 1030 diagnoses the cause of the abnormality as a cyberattack and generates an ECU security DTC 1084 corresponding thereto.

After the diagnosis is performed and the actuator is operated based thereon, when it is determined that a sensor error actually occurs, ECU security freeze-frame data 1085 is generated, and a malfunction indicator lamp may be lit on the cyber dashboard 160.

In an embodiment, when a patch or maintenance is required because a cybersecurity problem occurred, the ECU electronic control software 1030 may be updated using a remote software (FOTA) update server 194.

In an embodiment, various security methods may be applied in order to diagnose, at boot time or runtime, whether the integrity of the ECU software is broken. In order to verify and diagnose whether the ECU electronic control software 1030 is illegally altered by a cyberattack, the present invention may apply technologies including a hardware security module 1110 for verifying ECU software integrity.

In an embodiment, when the ECU electronic control software 1030 is updated normally through the ECU software (FOTA) update function block 1050, the integrity verification value of the updated electronic control software may be stored in the ECU hardware security module so as to enable the control software integrity to be verified at diagnosis time.

The present invention may include a method in which, when the result of verification of the integrity 1110 of the ECU electronic control software is determined to be a defect in the integrity, an ECU security DTC 1084 and security freeze-frame data 1085 corresponding thereto are generated and stored in the ECU security diagnostic memory 1080 so as to be retrieved using a cybersecurity diagnostic tool 192.

In an embodiment, “control software integrity” may be defined as a subfield of the cybersecurity OBD Parameter ID 1230, as shown in FIG. 12, in order to diagnose the integrity of the ECU electronic control software. In an embodiment, when the current integrity verification value, stored in the hardware security module 1110 for verifying ECU software integrity, is different from the integrity verification value of the ECU electronic control software, which is measured using the conventional method at the diagnosis time, it is determined that the value of the “control software integrity” field exceeds the tolerance limit of the attack sign value 1250, and the result may be stored as the security state 1082 of the ECU electronic control software.

In an embodiment, a defect in the integrity of ECU electronic control software may be displayed on the cyber dashboard 160, or an ECU security DTC 1084 and security freeze-frame data 1085 corresponding thereto may be generated and stored in the ECU security diagnostic memory 1080 so as to be retrieved using the cybersecurity diagnostic tool 192.

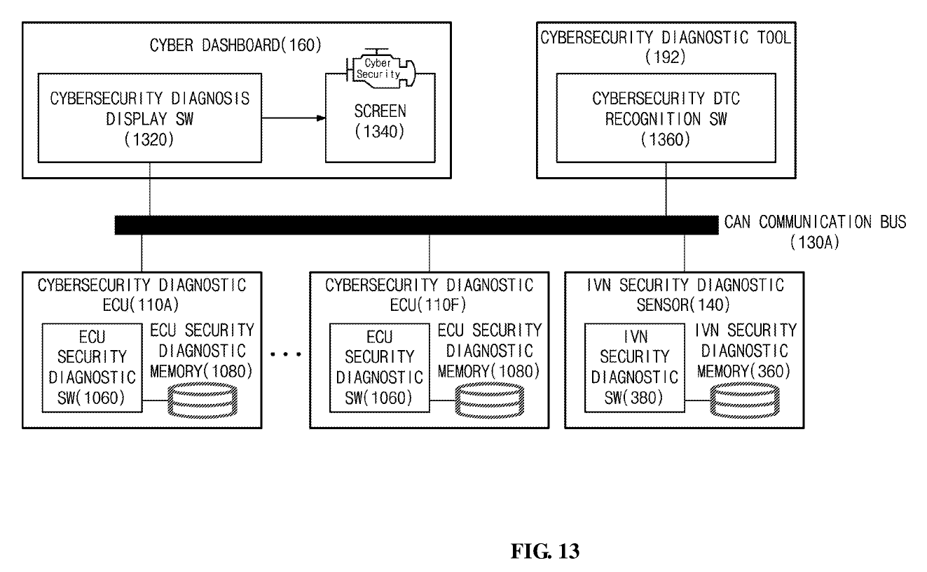

FIG. 13 is an exemplary diagram that shows an onboard cybersecurity diagnostic system for a vehicle according to an embodiment of the present invention. Referring to FIG. 13, the onboard cybersecurity diagnostic system for a vehicle may include multiple ECUs 110A to 110F, an IVN security diagnostic sensor 140, a cyber dashboard 160 for outputting a cybersecurity alarm, and a cybersecurity diagnostic tool 192 for scanning a cybersecurity state.

In an embodiment, a vehicle device for an interface with a driver, such as an instrument cluster, a Head-up Display (HUD), or a head unit, may be applied to the cyber dashboard 160.

In an embodiment, the cyber dashboard 160 may include cybersecurity diagnosis display software 1320. In an embodiment, the cybersecurity diagnosis display software 1320 interprets a cybersecurity DTC 366 or security freeze-frame data 367 or 1085, which are transmitted by the ECU 110 or the IVN security diagnostic sensor 140, thereby notifying a driver of the occurrence of a cyberattack. Using this function, the driver may detect whether a vehicle maintains a safe state from the aspect of cybersecurity and the problem that the vehicle has if there is a problem.

In an embodiment, the cybersecurity diagnosis display software 1320 may output an alarm using any of various methods, such as a message, a sound, a lamp on an instrument cluster, graphics, or the like.

In an embodiment, when a cybersecurity problem is displayed on the cyber dashboard 160, a driver or an automotive technician may detect the cause of the defect by retrieving the security DTC 1084 and 366 and security freeze-frame data 1085 and 367 from the ECU security diagnostic memory 180 and the IVN security diagnostic memory 360 using the cybersecurity diagnostic tool 192 or the infotainment diagnostic app 196.

The cybersecurity diagnostic tool 192 according to an embodiment of the present invention may include cybersecurity DTC recognition software 1360. The cybersecurity DTC recognition software 1360 solves an error in which the cybersecurity DTC 366 and 1084 of FIG. 7, which is input to the cybersecurity diagnostic tool 192, is not recognized, thereby processing diagnosis request and response messages.

In an embodiment, the cybersecurity diagnostic tool 192 may diagnose the cybersecurity state of a vehicle using the security diagnostic tool 192 connected with an OBD interface 172, which is the conventional method used in a garage, a sensor/OBD parameter ID 610 or 1230 (e.g., the diagnostic ID of the “control software integrity” field in FIG. 12), and a cybersecurity DTC 366 or 1084.

In an embodiment, when an automotive technician inputs a cybersecurity OBD PID 610 or 1230 or a cybersecurity DTC 366 or 1084, a diagnosis request message is transmitted to the CAN communication bus, and the ECU 110 or the IVN security diagnostic sensor 140 responsible for the corresponding cybersecurity OBD PID or cybersecurity DTC may recognize the request and output a suitable diagnostic value or cybersecurity freeze-frame data 1085 or 367. Then, the cybersecurity diagnostic tool 192 may read the output value or data and display the same on the screen.

The onboard cybersecurity diagnostic system for a vehicle according to an embodiment of the present invention includes one or more in-vehicle network (IVN) security diagnostic sensors, one or more cybersecurity diagnostic ECUs, a cyber dashboard, a cybersecurity diagnostic tool, cybersecurity diagnostic trouble codes, and cybersecurity freeze-frame data. Accordingly, the onboard cybersecurity diagnostic system for a vehicle may autonomously diagnose a cybersecurity problem in the ECU, in which software is embedded, and display the state of malfunction, thereby providing a method for fixing the cause of the cybersecurity problem.

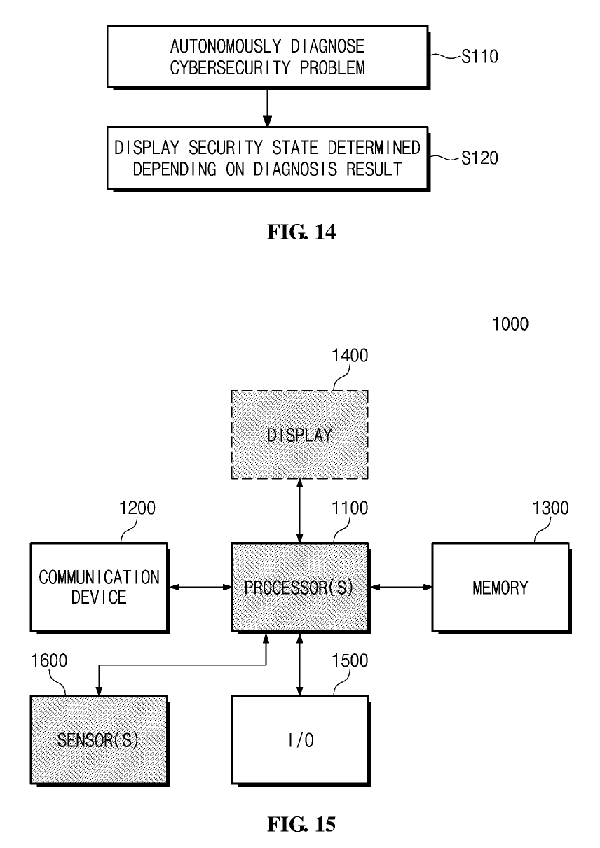

FIG. 14 is a flowchart that shows the operation method of a cybersecurity diagnostic system for a vehicle. Referring to FIGS. 1 to 14, the cybersecurity diagnostic system for a vehicle may operate as follows.

The ECU may autonomously diagnose a cybersecurity problem at step S110. The cyber dashboard may display a security state acquired as the diagnosis result at step S120. Here, the ECU may include a hardware security module (HSM) for verifying the integrity of ECU electronic control software and ECU security diagnostic memory, which stores a sensor/OBD parameter ID, sensor data, the security state of the sensor data, an ECU security DTC, and ECU security freeze-frame data therein. In an embodiment, the ECU electronic control software combines the sensor data received from sensors with security diagnostic data (security diagnostic packets) received from the IVN security diagnostic sensor, thereby verifying the integrity of ECU control data.

Depending on an embodiment, some or all of the steps and/or operations may be implemented or performed using one or more processors executing instructions, programs, interactive data structures, and client and/or server components stored in one or more nonvolatile computer-readable storage media. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. The one or more nonvolatile computer-readable media may be, for example, software, firmware, hardware, and/or a combination thereof. Also, the functionality of any “module” discussed herein may be implemented in software, firmware, hardware, and/or any combination thereof.

The one or more nonvolatile computer-readable media and/or means for implementing or performing one or more operations, steps, and modules of the embodiments of the present invention may include application-specific integrated circuits (ASICs), standard integrated circuits, controllers executing suitable instructions (including microcontrollers and/or embedded controllers), field-programmable gate arrays (FPGAs), complex programmable logic devices (CPLDs), and the like, but the components that may be included therein are not limited to these examples.

The onboard cybersecurity diagnostic system for a vehicle according to an embodiment of the present invention includes a cybersecurity diagnostic sensor in a vehicle, and may be embodied as a product operating in conjunction with an ECU and a cyber dashboard. Accordingly, a cyberattack diagnosis result may be output using the UI of the cyber dashboard. Also, because the onboard cybersecurity diagnostic system for a vehicle according to an embodiment of the present invention is configured such that a cybersecurity diagnostic trouble code (DTC) and cybersecurity freeze-frame data are scanned using the conventional OBD2 scanning tool, an operation depending on the cybersecurity DTC may be checked using the UI of the scanning tool.

Meanwhile, in FIG. 1, the cyber dashboard 160 has been described as being connected with multiple ECUs via a communication bus. However, the present invention is not limited thereto. The security diagnostic device for a vehicle according to the present invention may alternatively be implemented in a single product so as to be installed in the vehicle.

FIG. 15 is an exemplary diagram that shows a cybersecurity diagnostic device for a vehicle according to an embodiment of the present invention. Referring to FIG. 15, the cybersecurity diagnostic device 1000 may include at least one processor 1100, a network interface 1200, memory 1300, a display 1400, input/output devices 1500, and at least one sensor 1600. The at least one sensor 1600 may be implemented to diagnose the cybersecurity state of the vehicle.

The processor 1100 may include at least one of the devices described with reference to FIGS. 1 to 14, or may be implemented using at least one of the methods described with reference to FIGS. 1 to 14. The processor 1100 may determine the cybersecurity state of a vehicle using information collected from the at least one sensor 1600 and display the result on the display 1400, as described above.

The network interface 1200 may be implemented so as to communicate with a vehicle network using various wired/wireless methods.

The memory 1300 may store computer-readable instructions or commands. The processor 1100 may perform the above-described operations by executing the instructions stored in the memory 1300. The memory may be volatile or nonvolatile memory. The memory 1300 may include a storage device in order to store user's data. The storage device may be an embedded multimedia card (eMMC), a solid-state drive (SSD), universal flash storage (UFS), or the like. The storage device may include at least one nonvolatile memory device. The nonvolatile memory device may be any one of NAND flash memory, Vertical NAND (VNAND), NOR flash memory, Resistive Random-Access Memory (RRAM), Phase-Change Memory (PRAM), Magnetoresistive Random-Access Memory (MRAM), Ferroelectric Random-Access Memory (FRAM), Spin-Transfer-Torque Random-Access Memory (STT-RAM), and the like.

The present invention improves the conventional technology for diagnosing a vehicle and provides a technical means through which not only physical faults but also a defect caused by a cyberattack may be diagnosed and fixed.

When a vehicle system damaged by a cyberattack causes an accident, the conventional technology for diagnosing a physical fault is not able to determine whether the cause of the accident is deterioration of the part of a vehicle, a driver's mistake, or the defect caused by a cyberattack. However, the present invention provides a technical method for autonomously diagnosing a cybersecurity problem, which causes an accident by illegally damaging the ECU electronic control software of a vehicle and ECU control (sensor) data, and for outputting the security state to an attack target ECU, a driver, or an automotive technician. Using such a technical means, a driver may detect whether a vehicle maintains a safe state from the aspect of cybersecurity and the kind of problem that is present when the vehicle is determined to have a problem in an environment in which a malicious cyberattack is possible, whereby the safety of the driver may be improved.

Furthermore, a vehicle's ECU checks the integrity of ECU electronic control data by combining the conventional sensor data with cybersecurity diagnostic data generated in an in-vehicle electronic system network, and runs electronic control software based thereon, whereby an ECU operation method that is secure against a cyberattack may be provided.

The cybersecurity diagnostic system for a vehicle according to an embodiment of the present invention may autonomously diagnose a cybersecurity problem of the onboard system of the vehicle using an OBD interface, such as Onboard Diagnostics II (OBD2), a Modular Vehicle Communication Interface (MVCI), or Diagnostics over Internet Protocol (DOIP) in an environment in which vehicle sensors and onboard ECUs are connected with each other via an internal network, thereby displaying freeze-frame data, acquired from the sensors and components of the vehicle at the time when a fault attributed to a cyberattack is detected.

The onboard cybersecurity diagnostic system for a vehicle, the electronic control unit (ECU), and the operation methods thereof according to an embodiment of the present invention improve the conventional technology for diagnosing a vehicle, thereby enabling not only a physical fault but also a defect attributable to a cyberattack to be diagnosed and fixed.

The onboard cybersecurity diagnostic system for a vehicle, the ECU, and the operation methods thereof according to an embodiment of the present invention enable a vehicle to autonomously diagnose a cybersecurity problem, which may cause a malfunction by illegally corrupting a vehicle's ECU electronic control software and ECU control (sensor) data, and to output the security state to the ECU that is the target of an attack, a driver, or an automotive technician.

The onboard cybersecurity diagnostic system for a vehicle, the ECU, and the operation methods thereof according to an embodiment of the present invention enable a driver to detect whether a vehicle maintains a safe state from the aspect of cybersecurity and to detect what kind of problem is present if the vehicle is determined to have a problem in an environment in which a malicious cyberattack is possible, whereby the safety of the driver may be improved.

The onboard cybersecurity diagnostic system for a vehicle, the ECU, and the operation methods thereof according to an embodiment of the present invention may secure an ECU operating method that is secure against a cyberattack in such a way that the ECU of the vehicle combines sensor data, which is collected using the conventional method, with cybersecurity diagnostic data, generated in an in-vehicle electronic system network, determines whether or not the integrity of ECU control data is maintained, and operates electronic control software based thereon.

Meanwhile, the above description is merely specific embodiments for practicing the present invention. The present invention encompasses not only concrete and available means but also the technical spirit corresponding to abstract and conceptual ideas that may be used as future technology.

What is claimed is:

1. An onboard cybersecurity diagnostic system for a vehicle, comprising:
at least one In-Vehicle Network (IVN) security diagnostic sensor configured to detect and diagnose an Electronic Control Unit (ECU) attack command on a communication bus;
at least one ECU configured to control an actuator based on sensor data collected from a sensor, autonomously diagnose integrity of ECU electronic control software, and diagnose integrity of ECU electronic control data by combining the sensor data with a security diagnostic packet received from the at least one IVN security diagnostic sensor; and
a cyber dashboard configured to display a security problem in an event of the security problem in the integrity of the ECU electronic control software or the integrity of the ECU electronic control data.

2. The onboard cybersecurity diagnostic system of claim 1, wherein the communication bus includes a vehicle communication bus.

3. The onboard cybersecurity diagnostic system of claim 1, wherein the communication bus includes a gateway for connection with an outside of the vehicle and an internal communication bus of the vehicle.

4. The onboard cybersecurity diagnostic system of claim 1, further comprising:
a cybersecurity diagnostic tool configured to scan data stored in IVN security diagnostic memory of the at least one IVN security diagnostic sensor and security diagnostic data stored in diagnostic memory of the at least one ECU, thereby performing precision test.

5. The onboard cybersecurity diagnostic system of claim 1, wherein the at least one IVN security diagnostic sensor comprises:
an IVN attack detection sensor configured to identify a driving state of the vehicle, identify an attacker device and an attack target ECU, and detect a cyberattack;
an IVN security diagnostic memory configured to store information about the identified attacker device and the identified attack target ECU when the cyberattack is detected; and
an IVN security diagnostic software block for generating a security diagnostic trouble code (DTC) and security freeze-frame data based on a cyberattack detection result stored in the IVN security diagnostic memory.

6. The onboard cybersecurity diagnostic system of claim 5, wherein the at least one IVN security diagnostic sensor generates a security diagnosis alarm packet using the security DTC and the security freeze-frame data and transmits the security diagnosis alarm packet to the identified attack target ECU and the cyber dashboard.

7. The onboard cybersecurity diagnostic system of claim 5, wherein the IVN attack detection sensor identifies the attacker device and the attack target ECU by analyzing reception characteristics of a Controller Area Network (CAN) packet on the communication bus after identifying the driving state of the vehicle.

8. The onboard cybersecurity diagnostic system of claim 7, wherein the IVN attack detection sensor extracts a set of characteristics for uniquely identifying an ECU, thereby detecting whether the attacker device transmits a CAN_ID for a forcible control attack on the ECU and identifying the ECU at which the attack is aimed.

9. The onboard cybersecurity diagnostic system of claim 7, wherein the IVN attack detection sensor extracts characteristics of an ECU fingerprint and analyzes a correlation between a received CAN_ID and the ECU, thereby identifying the attacker device and the attack target ECU.

10. The onboard cybersecurity diagnostic system of claim 9, wherein the ECU fingerprint includes a time interval at which the CAN_ID is received, a frequency with which the CAN_ID is received, or a period at which the CAN_ID is received as a statistical characteristic value of a received CAN message.

11. The onboard cybersecurity diagnostic system of claim 9, wherein the ECU fingerprint includes a reception power value as a physical characteristic value of the CAN packet, which is measured at a CAN transceiver.

12. The onboard cybersecurity diagnostic system of claim 5, wherein:
the IVN attack detection sensor detects an attack using the driving state of the vehicle and an attack detection rule, and
the attack detection rule includes a detection rule for an individual CAN packet and a detection rule using a time-series correlation between CAN packets received over time.

13. The onboard cybersecurity diagnostic system of claim 5, wherein the security DTC includes a code for differentiating an area in which an attack has occurred and for diagnosing a type of the attack or damage caused by the attack.

14. The onboard cybersecurity diagnostic system of claim 5, wherein the security DTC includes an MIL code for immediately lighting a cybersecurity Malfunction Indicator Lamp (MIL) on the cyber dashboard when a cyberattack is serious enough to compromise safety of the vehicle so it is necessary to urgently respond thereto.

15. The onboard cybersecurity diagnostic system of claim 14, wherein the security freeze-frame data includes different data depending on a device in which the security DTC is generated and a condition under which an attack has occurred.

16. The onboard cybersecurity diagnostic system of claim 1, wherein the at least one ECU includes ECU security diagnostic memory for storing an ECU security diagnostic trouble code and ECU security freeze-frame data, which correspond to a result of verification of the integrity of the ECU electronic control software.

17. An electronic control unit (ECU) for controlling an actuator, comprising:
a hardware security module configured to verify integrity of ECU electronic control software; and
ECU security diagnostic memory configured to store a sensor/onboard diagnostic (OBD) parameter ID, sensor data, a security state of the sensor data, an ECU security diagnostic trouble code (DTC), and ECU security freeze-frame data,
wherein the ECU electronic control software verifies integrity of ECU control data by combining the sensor data received from a sensor with security diagnostic data received from an In-Vehicle Network (IVN) security diagnostic sensor.

18. The ECU of claim 17, wherein:
the security state of the sensor data includes an attack sign value, which is calculated by taking a value measured by and input from the sensor and a diagnostic value received from the IVN security diagnostic sensor as input variables, and a number of times the ECU security DTC is continuously generated;
the ECU security DTC includes content that represents a security problem by which integrity of the ECU electronic control software and ECU control data of a specific ECU is damaged; and
the ECU security freeze-frame data includes the sensor/OBD parameter ID, a time at which a diagnosis is made, data about a driving state, and ECU security diagnostic data related to the security problem, the ECU security diagnostic data including a result of diagnosing the integrity of the ECU electronic control software or a data value indicating a sign of an attack on the ECU electronic control software.

19. The ECU of claim 18, wherein the ECU electronic control software sets the ECU security DTC when the data value indicating the sign of the attack relative to the value measured by the sensor exceeds a tolerance limit and when a time-series sequence pattern of the values measured by the sensor is an abnormal sequence pattern.

20. An operation method of an onboard cybersecurity diagnostic system for a vehicle, comprising:
autonomously diagnosing, by an electronic control unit (ECU), a cybersecurity problem; and
displaying a security state determined depending on a diagnosis result on a cyber dashboard,
wherein the ECU comprises:
a hardware security module configured to verify integrity of ECU electronic control software; and
ECU security diagnostic memory configured to store a sensor/onboard diagnostic (OBD) parameter ID, sensor data, a security state of the sensor data, an ECU security diagnostic trouble code (DTC) and ECU security freeze-frame data,
the ECU electronic control software verifying integrity of ECU control data by combining the sensor data received from a sensor with security diagnostic data received from an In-Vehicle Network (IVN) security diagnostic sensor.
